(19) United States
(12) Patent Application Publication
(10) Pub. No.: US 2016/0146145 A1
(43) Pub. Date: May 26, 2016

(54) METHOD AND CONTROL DEVICE FOR CORRECTING THE START OF INJECTION OF INJECTORS OF AN INTERNAL COMBUSTION ENGINE

(71) Applicant: MTU FRIEDRICHSHAFEN GMBH, Friedrichshafen (DE)

(72) Inventors: Michael WALDER, Ravensburg (DE); Andreas MEHR, Kressbronn (DE); Carsten ENGLER, Wolfegg (DE); Frank MLICKI, Radolfzell (DE); Christian WOLF, Langenargen (DE); Alexander BERNHARD, Meckenbeuren (DE)

(21) Appl. No.: 14/900,562

(22) PCT Filed: Jun. 16, 2014
(86) PCT No.: PCT/EP2014/001633

§ 371 Date: Dec. 21, 2015

(30) Foreign Application Priority Data
Jun. 20, 2013 (DE) 10 2013 211 728.0

(51) Int. Cl. F02D 41/24

(52) U.S. Cl. CPC F02D 41/2432; F02D 41/2467

(57) ABSTRACT

A method for correcting the start of injection of injectors of an internal combustion engine, including the following steps: determining a target start of current application depending on at least one parameter of the internal combustion engine; detecting a pressure in an individual accumulator of an injector and determining a measured start of injection on the basis of the pressure; determining a target injection delay depending on at least one parameter of the internal combustion engine; calculating an actual injection delay from the target start of current application and the measured start of injection; comparing the target injection delay and the actual injection delay; and calculating a start-of-current-application correction variable on the basis of the comparison and correcting the target start of current application by the start-of-current-application correction variable.

The invention pertains to a method for correcting the start of injection of injectors of an internal combustion engine according to claim 1 and to a control device for an internal combustion engine according to the introductory clause of claim 10.

German Offenlegungsschrift DE 102 32 356 A1 describes a method in which the start of injection of an injector is detected by a pressure sensor and compared with a value stored in a characteristic map. If a deviation is found, the start of injection is corrected in such a way that that this deviation disappears. A corresponding correction value is stored. Within the scope of the known method, the pressure sensor is configured as a rail pressure sensor or as a sensor in a pressure line leading to the injector. In the case of injectors of internal combustion engines, especially in the case of injectors of an injection system with a common high-pressure accumulator, namely, a so-called common-rail injection system, there is usually a time lag between the time at which current is applied, i.e., the time at which an injector is supplied with current, and the actual start of the injection through the injector, i.e., the start of injection. This time lag is also called the injection delay. The injection delay is usually dependent on the concrete injector being used. It is also subject to change over the life of the injector, i.e., of the internal combustion engine. The various injectors of an internal combustion engine therefore typically show different values for the start of injection even when they are supplied with current at exactly the same time. These values then also vary over the life of the internal combustion engine or of the individual injectors. To guarantee the stability of operation of the internal combustion engine, especially with respect to its emissions and power output, both when new and also over the course of its service life, the attempt is made by means of the known method, for example, to make sure that all the various injectors of the internal combustion engine are same with respect to the start of injection, which means in particular that they start to inject at the identical points in time at the same operating points of the internal combustion engine—preferably relative to the current stroke of the piston in the cylinder assigned to the injector under consideration. It has been found that the known method is in need of improvement, because the pressure measured by the rail pressure sensor or by the pressure sensor in the feed line to the injector does not allow a highly precise determination of the actual start of injection.

The invention is therefore based on the goal of creating a method which does not suffer from the disadvantage just mentioned. In particular, it should be possible with the help of the method to correct the start of injection of the injectors very precisely and exactly, wherein the method should also be easy to implement. The invention is also based on the goal of creating a control device for an internal combustion engine by means of which the method can be implemented.

The goal is achieved in that a method with the steps of claim 1 is created. Within the scope of the method, a target starting point for the application of current, i.e., the “target start of current application”, is determined as a function of at least one parameter of the internal combustion engine. A pressure is detected in an individual accumulator of an injector during an injection event, and on the basis of this detected pressure, a measured start of injection is determined. A target injection delay is determined as a function of at least one parameter of the internal combustion engine. An actual injection delay is calculated from the target start of current application and the measured start of injection. The target injection delay and the actual injection delay are compared. A start-of-current-application correction variable is calculated on the basis of the comparison, and the target start of current application is corrected by means of the start-of-current-application correction variable. Within the scope of the method, it is therefore possible to correct the start of current application for an individual injector and thus to obtain the desired actual start of injection. When, in particular, the method is implemented for all of the injectors of the internal combustion engine, it is also possible to make all of the various injectors of the internal combustion engine the same with respect to their start of injection. The method can be carried out easily both initially, i.e., prior to or during the initial startup of the internal combustion engine, and during its operating life to compensate for the drift of the individual injectors occurring over time.

The pressure in the individual accumulator is preferably detected as a time-resolved pressure curve and stored. From the stored pressure curve, the actual, i.e., measured, start of injection is determined, wherein a method suitable for this purpose is described in, for example, German Offenlegungsschrift DE 10 2009 056 381 A1, to which reference is herewith made in this respect. A method for determining the virtual start of injection on the basis of an individual accumulator pressure curve measurement is also known from German Offenlegungsschrift DE 103 44 181 A1, to which reference is also herewith made.

The method can be carried out for injection systems which comprise a common high-pressure accumulator, namely, a so-called common rail. Each injector of the injection system has its own individual accumulator as additional buffer volume. When current is applied, a needle in the nozzle of the injector is shifted and the nozzle is opened. There is a delay between the time at which the current begins to be applied and the time at which the nozzle needle arrives in a position at which the actual injection begins. This so-called injection delay varies from one injector to another, and it also varies over the life of an individual injector.

The method is especially precise and exact, because, to determine the actual measured start of injection, either the pressure or the pressure curve in the individual accumulator assigned directly to the injector is detected. As a result, the pressure is detected in a location very close to the actual point of injection, so that an especially accurate determination of the start of injection is possible. At the same time, therefore, it is also possible to correct the start of current application very precisely.

The method can carried out for any type of injection event. Thus, it is possible to carry out the method for a pre-injection, for a main injection, and/or for a post-injection. It is possible to state the target start of current application in units of degree crankshaft or in units of time, especially in ms. It is especially preferable to state the target start of current application for a main injection in degree crankshaft, whereas, for a pre-injection and a post-injection, it is preferably stated in units of time, especially in msec, and preferably as the length of time between it and the start of current application for the main injection.

The measured start of injection is preferably also determined in units of degree crankshaft. Alternatively, it is possible to determine the measured start of injection in units of time, especially in ms.

The target injection delay is preferably determined in units of time, especially ms. Alternatively, however, it is also possible to determine the target injection delay in units of degree crankshaft. This is somewhat more cumbersome, however, because then the rotational speed of the internal combustion engine must be used to determine the target injection delay.

The actual injection delay is preferably calculated in the same units as those in which the target injection delay is determined. As a result, it becomes easier to compare the target injection delay with the actual injection delay. Alternatively, it is possible to convert the actual injection delay into the units in which the target injection delay is determined, in the event that the actual injection delay is not calculated in these units.

The correction variable for the start of current application is preferably calculated in the same units as those in which the target start of current application is determined, or it is converted into these units, so that the target start of current application can be easily corrected.

A method is preferred in which the start-of-current-application correction variable is stored in a correction characteristic map assigned to the injector. Alternatively, it is possible for the start-of-current-application correction variable to be stored in a correction characteristic map which is provided as a global field for all of the injectors, wherein, however, it comprises a parameter for assigning the inputs value to the individual injectors, so that the start-of-current-application correction variable can be stored on an individual basis in the characteristic map for the injectors under consideration. This alternative approach ultimately leads to the same result as the previously described approach, in which a separate characteristic correction map is assigned to each injector. In both cases, namely, the start-of-current-application correction variable is assigned individually to an injector, so that a correction of the start of current application or of the start of injection for the injectors of the internal combustion engine can be carried out individually for each injector. Especially preferably, a target start of current application globally predetermined for all of the injectors is recalculated on the basis of the start-of-current-application correction variable stored for each individual injector in order to establish the individual start of current application for each injector. In this way, it is possible in particular to make all the injectors of the internal combustion engine the same with respect to start of their injections.

The start-of-current-application correction variable is preferably stored in the correction characteristic map as a function of a quantity of the fuel to be injected, in particular as a function of a volume of fuel to be injected or of a mass of fuel to be injected, and as a function of the pressure at the start of injection. This start-of-injection pressure indicates the pressure which is present at the injector prior to or immediately at the start of injection. This pressure corresponds both to a pressure prevailing in the individual accumulator at the time in question and to a pressure prevailing in the common high-pressure accumulator at the same point in the time. These accumulators are in fluid connection with each other, and when the injector is closed, no fuel flows, which means that the same static pressure is present in both the common high-pressure accumulator and the individual accumulator. It is therefore possible to detect the start-of-injection pressure by means of a pressure sensor provided in the area of the common high-pressure accumulator, i.e., a rail pressure sensor, whereas the pressure in the individual accumulator needed to determine the start of injection is detected by means of an individual accumulator pressure sensor provided in the accumulator. Because the pressure in the common high-pressure accumulator varies less over time than the pressure in the individual accumulators, it is advantageous to use the start-of-injection pressure measured in the area of the common high-pressure accumulator as the input value for characteristic maps comprising values dependent on the start-of-injection pressure.

A method is preferred in which the target start of current application is read out from a map of current application characteristics. The values for the target start of current application are stored in this current application map as a function of at least one parameter of the internal combustion engine. It is especially preferable for the values to be stored in the current application map as a function of a rotational speed of the internal combustion engine and as a function of a required torque or of a required load on the internal combustion engine. The target start of current application therefore varies preferably with the rotational speed and the load requirement, i.e., overall with the operating or load point of the internal combustion engine. The current application map preferably comprises values which are averaged over a large number of injectors, especially preferably over a number of injectors on the order of approximately 100. Accordingly, it is preferably provided globally for all of the injectors.

A method is preferred which is characterized in that the target injection delay is read out from a map of injection delay characteristics. This is preferably a characteristic map which comprises values which are averaged over a large number of injectors, especially over a number of injectors on the order of approximately 100. The values for the target injection delay in the injection delay map are preferably correlated with the values for the target start of current application in the start-of-current-application map in such a way that, under the assumption that the target injection delay for an injector is in fact realized, a start of injection adapted to the operating point is realized when the target start of current application filed in the current application map is applied to the injector. The values for the target start of injection are stored in the injection delay map as a function of at least one parameter of the internal combustion engine. The values for the target injection delay are preferably stored as a function of the quantity of fuel to be injected and also as a function of the start-of injection pressure. It has been found that, from a physical viewpoint, the injection delay does not actually depend on the quantity of fuel to be injected. In fact, however, the algorithms typically used to determine the variables relevant here result in at least a mathematical relationship between the target injection delay and the quantity of fuel injected. Accordingly, therefore, the start-of-current-application correction variable is preferably also stored in the correction map as a function of both the quantity of fuel to be injected and as a function of the pressure at the start of injection.

A method is also preferred which is characterized in that the actual injection delay is calculated by subtracting the target start of current application and the measured start of injection from each other. The target start of current application is preferably subtracted from the measured start of injection. In this way, a positive value is usually obtained for the actual injection delay, because typically the measured start of injection follows the target start of current application and therefore—regardless of whether this is stated in units of degree crankshaft or in units of time—has a larger value than the target value. Alternatively, it is also possible to calculate the actual injection delay by subtracting the measured start of injection from the target start of current application. In this case, a negative value is usually obtained for the actual injection delay. This does not present a problem for the rest of the method, however, wherein it is merely necessary to take the choice of the sign appropriately into account in the subsequent steps.

A method is preferred which is characterized in that the target injection delay and the actual injection delay are compared with each other, and in that the difference between the target injection delay and the actual injection delay is calculated. The actual injection delay is preferably subtracted from the target injection delay. This is especially preferred when the actual injection delay is calculated by subtracting the target start of current application from the measured start of injection. Alternatively, however, it is possible to calculate the difference by subtracting the target injection delay from the actual injection delay. This approach is preferred when the actual injection delay is calculated by subtracting the measured start of injection from the target start of current application. It has been found that, especially with respect to the calculation of the actual injection delay on the one hand and the comparison of the target injection delay with the actual injection delay on the other hand, it is important for the signs to be selected so that they match, i.e., that the corresponding variables are defined so that they are compatible with each other.

A method is also preferred which is characterized in that the start-of-current-application correction variable is calculated as the difference between the target injection delay and the actual injection delay. Thus the start-of-current-application correction variable is preferably obtained directly from the comparison between the target injection delay and the actual injection delay without the need for any additional calculating steps.

A method is also preferred which is characterized in that the start-of-current-application correction variable is weighted. The weighting serves in particular to compensate for outliers and thus results in a certain damping or delay of the control realized by the method especially for the purpose of avoiding the situation that the start of injection, as a result of short-term events, is shifted to a boundary. To this extent, the curve describing the start of current application over time controlled by the method is smoothed out by the weighting. As part of the weighting process, the absolute value of the start-of-current-application correction variable is preferably decreased without changing its sign. This can be done, for example, by multiplying the start-of-current-application correction variable by a weighting factor or by dividing the start-of-current-application correction variable by a weighting parameter. In either case, a parameterizable weighting is preferably used, wherein the weighting parameter—either as a factor or as a divisor—is selected preferably as a function of the quantity of fuel to be injected and also as a function of the start-of-injection pressure. The weighting parameter is preferably read out from a characteristic map comprising values stored as a function of the variables just mentioned. Of course, other forms of weighting, especially those which make use of a weighting parameter, are also possible. The weighting is preferably carried out even before the start-of-current-application correction variable is stored in the correction characteristic map. This correction map then does not comprise the raw values for the start-of-current-application correction variable but rather values which have already been weighted.

Finally, a method is preferred which is characterized in that it is carried out for each injector of the internal combustion engine. A correction map is preferably assigned to each individual injector. Each injector, therefore, has its own set of individual start-of-current-application correction variables stored, preferably stored as a function of the quantity of fuel to be injected and the pressure at the start of injection. With the help of the method, the injectors of the internal combustion engine are preferably made the same with respect to the start of their injections. According to one embodiment of the method, it is provided that the various injectors are made the same initially, i.e., when the internal combustion engine is first put into service. This is the same as saying that all the injectors are made the same as each other when the internal combustion engine is new. Alternatively or in addition, it is provided that the injectors are made the same by means of the method during the operating life of the internal combustion engine in order to compensate for injector drift which occurs over the life of the injectors. “Making the injectors the same” means that an individual start of current application is assigned to each injector in such a way that all of the various injectors start to inject at the same time—relative to the phase of the piston in the cylinder assigned to the injector.

The goal is also achieved, finally, in that a control device for controlling an internal combustion engine with the features of claim 10 is created. The control device is characterized in that it is set up to implement a method according to one of the previously described embodiments. It is possible for the method steps to be permanently implemented in the hardware of the control device. Alternatively or in addition, a computer program product can be loaded into the control device, this product containing instructions on the basis of which the control device executes the method when the computer program product is running on the control device.

It is possible for the control device to comprise separate units to implement different steps of the method. For example, it is possible that the control device could comprise an engine control unit, which determines the target start of current application and corrects this by means of the start-of-current-application control variable for each individual injector and then applies current to the injectors. The engine control unit preferably also determines the target injection delay. It is possible for the individual accumulator pressure of the injectors to be detected in a separate analysis unit and for the measured start of injection to be determined on the basis of the detected pressure. In this case, the actual injection delay is preferably also determined in the analysis unit. Alternatively, it is possible that the actual injection delay could be determined in the engine control unit, wherein the analysis unit merely transmits the measured start of injection to the engine control unit. The comparison of the target injection delay with the actual injection delay can be carried out in the engine control unit or alternatively in the separate analysis unit. The analysis unit is preferably functionally connected to the engine control unit, so that in particular data can be exchanged between the two units. The calculation of the start-of-current-application control variable on the basis of the comparison can also be carried out either in the engine control unit or alternatively in the separate analysis unit.

In an alternative exemplary embodiment of the control device, it is provided that this device comprises a unit, especially an engine control unit, on which the entire method runs.

The control device preferably comprises a first interface, by which it is functionally connected to an individual accumulator pressure sensor. It preferably comprises a second interface, by which it is functionally connected to at least one injector for the purpose of supplying it with current. Finally, the control device preferably comprises a third interface, by which it is functionally connected to a rail pressure sensor in the area of the common high-pressure accumulator, wherein, by means of this rail pressure sensor, in particular the pressure at the start of injection is detected as an input variable for the various engine maps.

The method and the control device are provided for use in an internal combustion engine comprising an injection system, which preferably comprises a common high-pressure accumulator and individual accumulators as additional buffer volumes in the area of the individual injectors. The internal combustion engine is preferably configured as a reciprocating piston engine. It can be used to drive land vehicles, watercraft, especially ships, or aircraft. In the area of land vehicles, heavy vehicles are especially of interest such as self-driving harvesting vehicles, construction machines, strip-mining vehicles, rail coaches or locomotives for trains, and for vehicles provided for defensive purpose such as tanks. The internal combustion engine can also be used for stationary applications, such as for emergency power supply, in peak-load operation, or even for continuous-load operation. For example, it is conceivable that the internal combustion engine could be used in a block-type thermal power station. The stationary operation of auxiliary or secondary systems such as fire-extinguishing pumps on off-shore drilling rigs, is possible. The injection system is preferably used to inject liquid or gaseous fuel such as gasoline, diesel, kerosene, heavy oil, methanol, ethanol, a higher alcohol, natural gas, biogas, lean gas, or special gas. This list is not exhaustive. The injection system can e used to inject any desired fluid fuel adapted to the operation of an internal combustion engine with individual point injection, multi-point injection, and/or direct injection.

The invention is explained in greater detail below on the basis of the drawing:

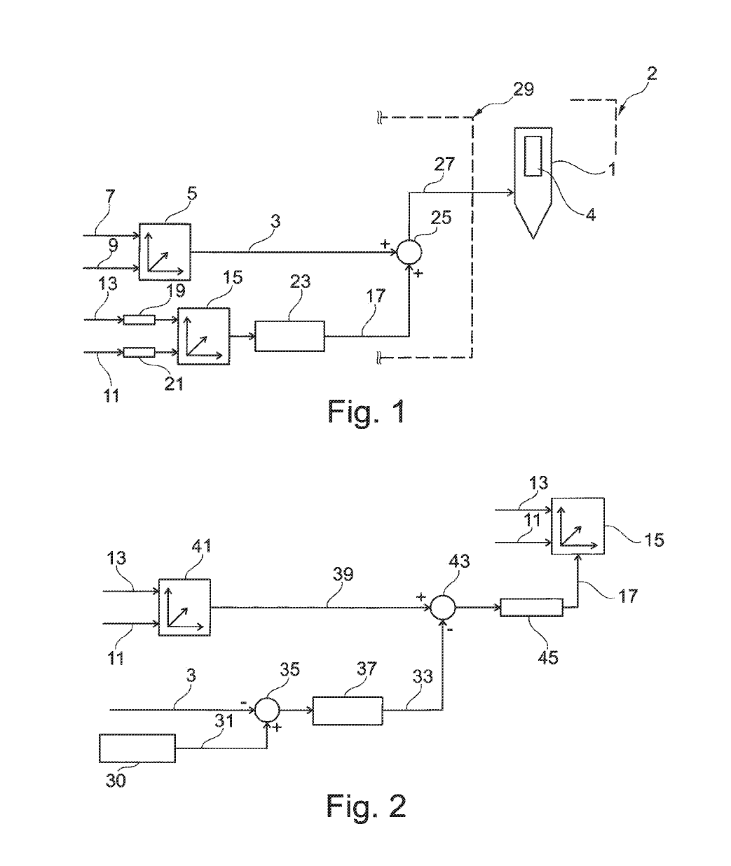

FIG. 1 shows a schematic, block diagram of the application of current to an injector according to one embodiment of the method; and

FIG. 2 shows a schematic block diagram of a correction of the start of current application within the scope of an embodiment of the method.

FIG. 1 shows a block diagram, in which the application of current to an injector 1 of an internal combustion engine 2 is illustrated schematically, wherein the injector 1 comprises an individual accumulator 4. Within the scope of the embodiment of the method shown here, a target start of current application 3 is determined preferably by an engine control unit as a function of at least one parameter of the internal combustion engine 2. In the control unit, the target start of current application 3 is read out from a current application map 5, in which values for the target start of current application 3 are stored as a function of a rotational speed 7 of the internal combustion engine 2 and as a function of a torque demand 9 on the internal combustion engine 2. Accordingly, the engine control unit reads out the target start of current application 3 from the current application map 5 as a function of the instantaneous rotational speed 7 and the instantaneous torque demand 9. The current application map 5 is set up as a global map, which means that it comprises values for the target start of current application 3 which have been averaged over a large number of injectors, preferably a number of injectors on the order of 100. Thus, as a function of the rotational speed 7 and the torque demand 9, the same global value for the target start of current application 3 is read out from the current application map 5 for each injector 1 of the internal combustion engine 2.

In addition, a start-of-injection pressure 11 is detected by a pressure sensor—preferably in the area of a common high-pressure accumulator. A fuel quantity to be injected 13 is also determined, preferably as the fuel mass or even more preferably as the fuel volume, by the engine control unit, especially as a function of the load point. The start-of-injection pressure 11 and the quantity of fuel to be injected 13 are sent as input variables to a correction map 15, from which a start-of-current-application correction variable 17 is read out as a function of the start-of-injection pressure 11 and the quantity of fuel to be injected 13. The correction map 15 comprises correction values for each individual injector; that is, the map is matched to the concrete injector 1, i.e., comprises values of the start-of-current-application correction variable 17 determined for this particular injector.

The quantity of fuel to be injected 13 and the start-of-injection pressure 11 are preferably filtered before they are read out from the correction map 15. For this purpose, in the exemplary embodiment illustrated here, two transfer elements 19, 21 are provided, wherein the transfer elements 19, 21 are preferably configured as low-pass elements and even more preferably as PT1 elements. Because an algorithm for evaluating the individual accumulator pressure is coupled directly to the speed controller of the internal combustion engine 2 by way of the quantity of fuel to be injected, the filtering prevents the internal combustion engine 2 from racing as a result of the automatic control process during the course of the method. Each of the transfer elements 19, 21 preferably comprises two time constants. A first time constant is defined for the steady-state operation of the internal combustion engine 2, i.e., for operating states in which a load point of the internal combustion engine 2 does not change. A second time constant is provided for transient operation of the internal combustion engine 2, in which the load point changes. The engine control unit preferably switches over from the use of one time constant to the other as appropriate to the operating state of the internal combustion engine 2, in particular by means of a bit, which can be set to 0 or 1 as a function of the operating state.

The target start of current application 3 is preferably stated in units of degree crankshaft i.e., is filed in these units in the current application map 5. In the embodiment of the method described here, however, the start-of-current-application correction variable 17 is filed in the correction map 15 in units of time, in particular in ms. A first conversion element 23 is therefore provided, by means of which the start-of-current-application correction variable 17 is converted from units of time to units of degree crankshaft. Depending on the units selected for the target start of current application 3 on the one hand and for the start-of-current-application correction variable 17 on the other, it is possible that the first conversion element 23 could, in a different embodiment of the method, carry out a different conversion or be eliminated completely.

The start-of-current-application correction variable 17 is here a summand, which is added—with a positive or a negative sign—in an addition element 25 to the target start of current application 3. In this way, the target start of current application 3 is corrected, i.e., a corrected start of current application 27 is calculated, by means of which the injector 1 is ultimately actuated.

The steps shown in FIG. 1 are preferably carried out by a control device 29, in particular by the engine control unit.

FIG. 2 shows a block diagram schematically representing the correction of the start of current application within the scope of one embodiment of the method. FIG. 2 shows in particular how the start-of-current-application correction variable 17 is obtained, i.e., how the correction map 15 is provided with its data for each individual injector. For this purpose, a pressure in the individual accumulator 4 of the injector 1 is detected, namely, in particular a time-resolved pressure curve, either by the engine control unit or—as shown in FIG. 2—by a separate analysis unit 30, wherein, on the basis of the pressure or of the time-resolved pressure curve, a measured start of injection 31 is determined.

An actual injection delay 33 is calculated on the basis of the target start of current application 3 and the measured start of injection 31 by the control device 29, in particular either by the engine control unit or by the separate analysis unit 30. In the case of the exemplary embodiment shown here, the target start of current application 3 is subtracted from the measured start of injection 31 in a first subtraction element 35.

As previously explained, the target start of current application 3 is preferably determined in units of degree crankshaft. Correspondingly, the measured start of injection 31 is also determined in units of degree crankshaft. Depending on the selected embodiment of the method, the actual injection delay is converted by a second conversion element 37 into different units, here in particular from degree crankshaft to units of time, preferably to ms. In the case of a different embodiment of the method, it is possible for the conversion element 37 to carry out a different conversion or for this conversion element to be omitted entirely.

The control device 29 determines a target injection delay 39 as a function of at least one parameter of the internal combustion engine 2. In the case of the embodiment of the method shown in FIG. 2, the target injection delay 39 is read out from an injection delay map 41, in which it is filed as a function of the quantity of fuel to be injected 13 and the start-of-injection pressure 11. Correspondingly, these variables are used as input variables for the injection delay map 41. The injection delay map 41 is preferably a global map, which comprises values for the target injection delay 39 averaged over a large number of injectors, preferably over a number of injectors on the order of 100. Correspondingly, as a function of the start-of-injection pressure 11 and the quantity of fuel to be injected 13, the same values for the target injection delay 39 are read out from the injection delay map 41 for all of the injectors 1 of the internal combustion engine 2.

The values for the target injection delay 39 are preferably filed in the injection delay map 41 in units of time, especially in ms. Therefore, the second conversion element 37 is preferably provided to convert he actual injection delay 33 into units of time.

The target injection delay 39 and the actual injection delay 33, possibly converted by the second conversion element 37, are compared with each other to calculate the start-of-current-application correction variable 17. For this purpose, in the embodiment of the method shown here, the actual injection delay 33 is subtracted from the target injection delay 39 in a second subtraction element 43. The start-of-current-application correction variable 17 is obtained as the difference between the target injection delay 39 and the actual injection delay 33, wherein, in the exemplary embodiment shown here, the start-of-current-application correction variable 17 is also weighted in a weighting element 45. The weighting is preferably parameterizable, wherein a weighting parameter is read out from a characteristic map (not shown) as a function of the quantity of fuel to be injected 13 and the start-of-injection pressure 11 and used for the weighting. The weighting parameter is preferably configured as a divisor, by which the difference between the target injection delay 39 and the actual injection delay 33 is divided.

The weighting in the weighting element 45 is preferably carried out in such a way that approximately 30-50 run-throughs of the method are required before all of the injectors 1 of the internal combustion engine 2 have been made the same. The control adjustment achieved by means of the method is thus preferably delayed by means of the weighting element 45 so that it is possible to compensate for outliers and to prevent the automatic control process from running immediately or very quickly into a boundary upon encountering an outlier.

The start-of-current-application correction variable 17 is thus ultimately calculated in this way and filed or stored in the individual injector correction map 15 for the injector 1 under consideration here as a function of the quantity of fuel to be injected 13 and the start-of-injection pressure 11.

The correction map 15 is thus updated continuously with new data during the course of the method, wherein, as shown in FIG. 1, the active start-of-current-application correction variable 17 is available at all times to calculate the corrected start of current application 27 from the target start of current application 3 and the start-of-current-application correction variable 17.

It is possible that all of the steps shown in FIG. 2—with the possible exception of the determination of the target start of current application 3, which can be provided by the engine control unit—could be carried out in the analysis unit 30. Alternatively, it is possible that the steps shown in FIG. 2 could be carried out by the engine control unit, whereas the analysis unit 30 merely determines the measured start of injection 31. In either case, however, both the analysis unit 30 and the engine control unit are part of the higher-level control device 29.

Finally, it is possible not to provide a separate analysis unit 30 but rather to implement it, so to speak, in the engine control unit, so that the measured start of injection 31 is also calculated by the engine control unit. In this case, the engine control unit is identical to the control device 29.

Overall, it has been found that, by means of the method and the control device 23, it is possible to correct the start of current application for the various injectors 1 of an internal combustion engine 2 not only initially but also during the operating life to compensate for injector drift, wherein the injectors 1 can be made the same with respect to their start of injection.

1-10. (canceled)

11. A method for correcting a start of injection of injectors of an internal combustion engine, comprising the steps of
determining a target start of current application as a function of at least one parameter of the internal combustion engine;
detecting a pressure in an individual accumulator of an injector and determining a measured start of injection based on the pressure;
determining a target injection delay as a function of at least one parameter of the internal combustion engine;
calculating an actual injection delay from the target start of current application and the measured start of injection;
comparing the target injection delay with the actual injection delay and calculating a start-of-current-application correction variable based on the comparison; and
correcting the target start of current application by the start-of-current-application correction variable.

12. The method according to claim 11, including storing the start-of-current-application correction variable in a correction characteristic map assigned to the injector.

13. The method according to claim 12, wherein the target start of current application is read out from the current application characteristic map.

14. The method according to claim 13, wherein the current application characteristic map includes values averaged over a large number of injectors.

15. The method according to claim 11, wherein the target injection delay is read out from an injection delay characteristic map.

16. The method according to claim 15, wherein the injection delay characteristic map includes values averaged over a large number of injectors.

17. The method according to claim 11, wherein the step of calculating the actual injection delay includes subtracting the target start of current application and the measured start of injection from each other.

18. The method according to claim 17, wherein the step of calculating the actual injection delay includes subtracting the target start of current application from the measured start of injection.

19. The method according to claim 11, wherein the steps of comparing the target injection delay with the actual injection delay includes calculating a difference between the target injection delay and the actual injection delay.

20. The method according to claim 19, wherein the actual injection delay is subtracted from the target injection delay.

21. The method according to claim 11, including calculating the start-of-current-application correction variable as a difference between the target injection delay and the actual injection delay.

22. The method according to claim 11, wherein the start-of-current-application correction variable is weighted.

23. The method according to claim 11, including carrying out the method out for each injector of the internal combustion engine, assigning a correction characteristic map to each injector, and making the injectors of the internal combustion engine equal with respect to the start of their injections.

24. A control device for an internal combustion engine, wherein the control device is configured to implement the method according to claim 10.
